(19) United States
(12) Patent Application Publication
(10) Pub. No.: US 2022/0070689 A1
(43) Pub. Date: Mar. 3, 2022

(54) COMMUNICATION DEVICE, COMMUNICATION CONTROL DEVICE, COMMUNICATION METHOD, AND COMMUNICATION CONTROL METHOD

(71) Applicant: SONY GROUP CORPORATION, TOKYO (JP)

(72) Inventor: HIROAKI TAKANO, TOKYO (JP)

(21) Appl. No.: 17/419,398

(22) PCT Filed: Dec. 11, 2019
(86) PCT No.: PCT/JP2019/048484

§ 371 Date: Jun. 29, 2021

(30) Foreign Application Priority Data
Jan. 9, 2019 (JP) 2019-002220

(51) Int. Cl. H04W 16/28; H04W 24/10; H04W 76/19; H04W 74/08

(52) U.S. Cl. CPC H04W 16/28; H04W 74/0833; H04W 76/19; H04W 24/10

(57) ABSTRACT

A communication device that includes an acquiring unit that acquires a beam link identifier in one to one correspondence with a measurement result of a beam relating to a beam transmitted from a base station; and a communication control unit that specifies a beam link with the base station to be suspended, by using the beam link identifier is provided.

### FIELD

The present disclosure relates to a communication device, a communication control device, a communication method, and a communication control method.

### BACKGROUND

The wireless access method and the wireless network of cellular mobile communication (hereinafter, also called “Long Term Evolution (LTE)”, “LTE-Advanced (LTE-A)”, “LTE-Advanced Pro (LTE-A Pro)”, “5h generation (5G)”, “New Radio (NR)”, “New Radio Access Technology (NRAT)”, “Evolved Universal Terrestrial Radio Access (EUTRA)”, or “Further EUTRA (FEUTRA)”) are considered in the third generation partnership project (3GPP). In the following explanation, LTE includes LTE-A, LTE-A Pro, and EUTRA, and NR includes NRAT and FEUTRA. In LTE and NR, a base station device (base station) is also called eNodeB (evolved Node B), and a terminal device (mobile station, mobile station device, terminal) is also called user equipment (UE). LTE and NR are cellular communication systems in which plural areas covered by a base station are arranged in a cell form. A single base station can manage plural cells.

For example, Patent Literature 1 discloses a frame to perform communication by using a beamform in a wireless communication system in which plural beam forming antennas are used.

### CITATION LIST

### Patent Literature

Patent Literature 1: JP-T-2014-524217

### SUMMARY

### Technical Problem

In an environment in which transmission is performed by beam forming from plural base stations, keeping a beam link with plural base stations is a load on a terminal device. Therefore, a system enabling a terminal device to avoid an unnecessary beam link from being kept has been demanded.

Accordingly, the present disclosure proposes new and improved communication device, communication control device, communication method, communication control method, and computer program that enable to reduce a load by avoiding an unnecessary beam link from being kept.

### Solution to Problem

According to the present disclosure, a communication device is provided that includes: an acquiring unit that acquires a beam link identifier in one to one correspondence with a measurement result of a beam transmitted from a base station; and a communication control unit that specifies a beam link with the base station to be suspended, by using the beam link identifier.

Moreover, according to the present disclosure, a communication device is provided that includes: an acquiring unit that acquires setting of priority of a beam to be used for a recovery request of a beam with respect to a base station; and a communication control unit that selects a beam to be used for a recovery request based on the priority.

Moreover, according to the present disclosure, a communication control device is provided that includes: a communication control unit that sets a beam link identifier in one to one correspondence with a measurement result of a beam from a terminal device relating to a beam to be transmitted; and an acquiring unit that acquires information relating to a beam link to be suspended by the terminal device receiving the beam, by using the beam link identifier.

Moreover, according to the present disclosure, a communication control device is provided that includes: a communication control unit that transmits setting of priority of a beam to be used for a recovery request of a beam with respect to a terminal device; and an acquiring unit that acquires information relating to a beam selected to be used for a recovery request based on the priority.

Moreover, according to the present disclosure, a communication method is provided that includes: acquiring a beam link identifier in one to one correspondence with a measurement result of a beam relating to a beam transmitted from a base station; and specifying a beam link to be suspended with respect to the base station, by using the beam link identifier.

Moreover, according to the present disclosure, a communication control method is provided that includes: setting a beam link identifier in one to one correspondence with a measurement result of a beam from a terminal device relating to a beam to be transmitted; and acquiring information relating to a beam link to be suspended by the terminal device that receives the beam by using the beam link identifier.

### BRIEF DESCRIPTION OF DRAWINGS

FIG. 1 is a diagram illustrating an example of an entire configuration of a system according to one embodiment of the present disclosure.

FIG. 2 is a diagram for explaining about a BWP.

FIG. 3 is a diagram for explaining about a beam sweeping.

FIG. 4 is a sequence diagram illustrating an example of a flow of a typical beam selection procedure and a CSI acquisition procedure performed by a base station and a terminal device.

FIG. 5 is a sequence diagram illustrating another example of a flow of a typical beam selection procedure and a CSI acquisition procedure performed by a base station and a terminal device.

FIG. 6 is a diagram for explaining an example of an analog-digital-hybrid antenna architecture.

FIG. 7 is an explanatory diagram illustrating an arrangement example of an antenna panel arranged in the terminal device.

FIG. 8 is a block diagram illustrating an example of a configuration of a base station according to the present embodiment.

FIG. 9 is a block diagram illustrating an example of a configuration of the terminal device according to the present embodiment.

FIG. 10 is an explanatory diagram illustrating an example of linkage between a beam report and a beam link.

FIG. 11 is a flowchart illustrating an example of operations of the base station and the terminal device according to the present embodiment.

FIG. 12 is an explanatory diagram indicating about a beam between the base station and the terminal device.

FIG. 13 is an explanatory diagram illustrating a state in which a resource to monitor a beam link failure is provided per beam.

FIG. 14 is an explanatory diagram illustrating a state in which a beam recovery request is made by the terminal device.

FIG. 15 is an explanatory diagram illustrating a state in which a beam recovery request is made by the terminal device.

FIG. 16 is an explanatory diagram illustrating a state in which the terminal device transmits plural beam recovery requests at the same time.

FIG. 17 is a flowchart illustrating an example of operations of the base station and the terminal device according to the present embodiment.

FIG. 18 is an explanatory diagram illustrating a state in which a beam recovery request is made by the terminal device.

FIG. 19 is a block diagram illustrating a first example of a schematic configuration of eNB.

FIG. 20 is a block diagram illustrating a second example of a schematic configuration of eNB.

FIG. 21 is a block diagram illustrating an example of a schematic configuration of a smartphone.

FIG. 22 is a block diagram illustrating an example of a schematic configuration of a car navigation device.

### DESCRIPTION OF EMBODIMENTS

Hereinafter, exemplary embodiments of the present disclosure will be explained in detail with reference to the accompanying drawings. An identical reference sign is assigned to components having a substantially identical functional configuration throughout the specification and drawings, and duplicated explanation will be thereby omitted.

Explanation will be given in following order.

### 1. Introduction

1.1. System Configuration

1.2. Related Art

1.3. Overview of Proposed Technique

### 2. Configuration Example

2.1. Configuration Example of Base Station

2.2. Configuration Example of Terminal Device

### 3. First Embodiment

### 4. Second Embodiment

### 5. Application

### 6. Summary

### 1. INTRODUCTION

### 1.1. System Configuration

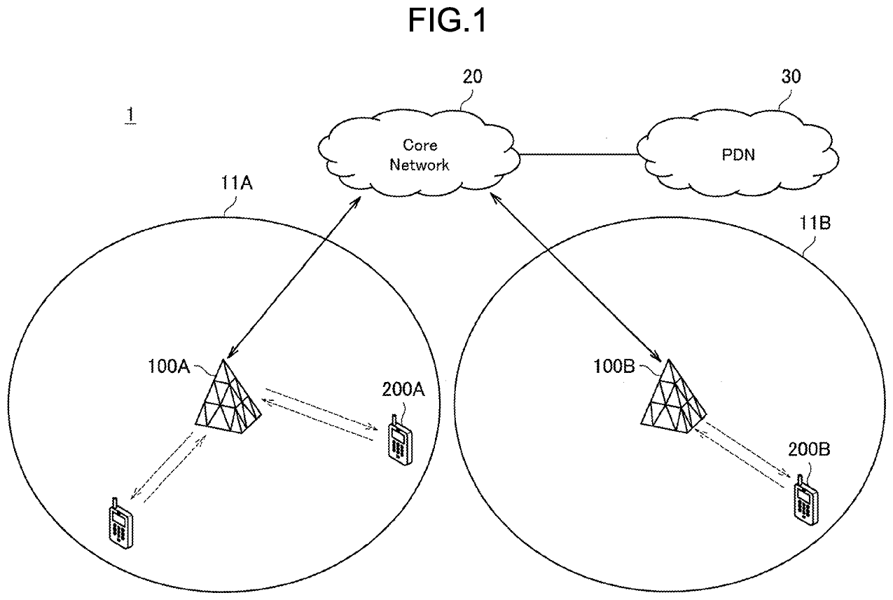

FIG. 1 is a diagram illustrating an example of an entire configuration of a system 1 according to one embodiment of the present disclosure. As illustrated in FIG. 1, the system 1 includes a base station 100 (100A and 100B), a terminal device 200 (200A and 200B), a core network 20, and a packet data network (PDN) 30.

The base station 100 is a communication device that operates a cell 11 (11A and 11B), and that provides a wireless service to one or more terminal devices positioned in the cell 11. For example, the base station 100A provides the wireless service to the terminal 200A, and the base station 100B provides the wireless service to the terminal 200B. The cell 11 can be operated in accordance with an arbitrary wireless communication system, for example, LTE, new radio (NR), or the like. The base station 100 is connected to the core network 20. The core network 20 is connected to the PDN 30.

The core network 20 can include, for example, a mobility management entity (MME), a serving gateway (S-GW), PDN gateway (P-GW), policy and charging rule function (PCRF), and home subscriber server (HSS). The MME is a control node that handles signals of control plane, and manages a moving state of the terminal device. S-GW is a control node that handles signals of user plane, and is a gateway device that switches a transfer route of user data. The P-GW is a control node that handles signals of user plane, and is a gateway device to be a connecting point between the core network 20 and the PDN 30. The PCRF is a control node that performs a control relating to a policy, such as quality of service (QoS) for bearer, and accounting. The HSS handles subscriber data, and is a control node that performs a service control.

The terminal device 200 is a communication device that performs wireless communication with the base station 100 based on a control by the base station 100. The terminal device 200 may be a so-called user equipment (UE). For example, the terminal device 200 transmits an uplink signal to the base station 100, and receives a downlink signal from the base station 100.

### 1.2. Related Art

### 1. Bandwidth Part (BWP)

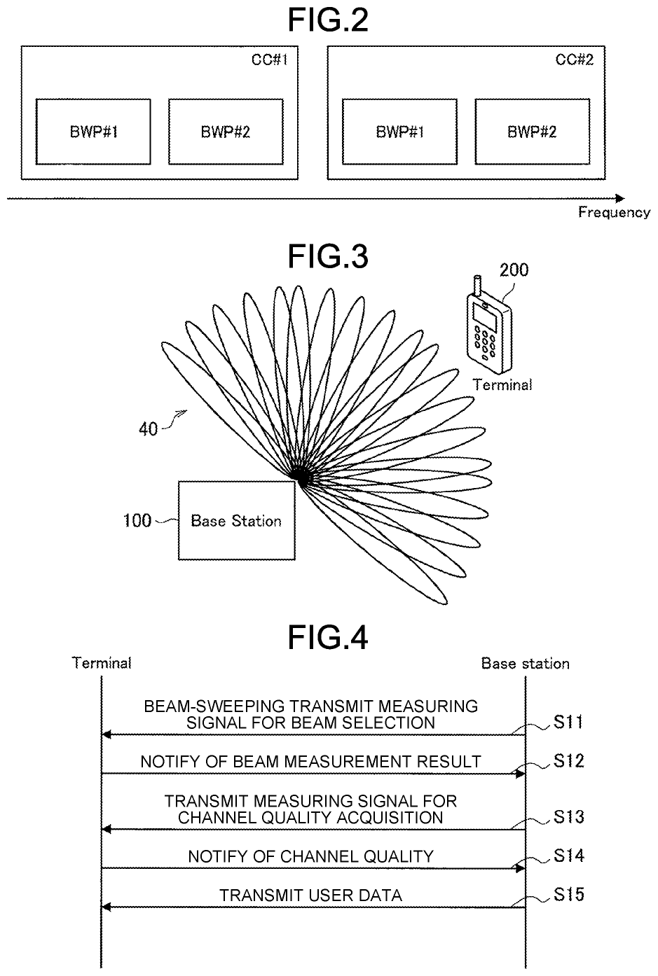

FIG. 2 is a diagram for explaining about the BWP. As illustrated in FIG. 2, CC #1 includes plural BWP (#1 and #2), and CC #2 includes plural BWP (#1 and #2). In the present application, a number after # indicates an index. BWPs included in different CC are different BWPs even if the index is the same. The BWP is obtained by dividing CC, which is a single operation band width, into plural band widths. In the respective BWPs, different subcarrier spacing can be set.

This BWP has been standardized as a basic frame format of NR of 3GPP Rel. 15. For LTE, the subcarrier spacing has been fixed to 15 kHz in the OFDM modulation method standardized by Rel. 8. On the other hand, in Rel. 15, the subcarrier spacing can be set to 60 kHz, 120 kHz, or 240 kHz. As the subcarrier spacing increases, the OFDM symbol duration increases. For example, in LTE, because the subcarrier spacing is 15 kHz, it has been possible to transmit 1 slot per 1 ms, in other words, it has been possible to transmit 14 OFDM symbols. On the other hand, in NR, it has been possible to transmit 2 slots when the subcarrier spacing is 60 kHz, 4 slots when the subcarrier spacing is 120 kHz, and 8 slots when the subcarrier spacing is 240 kHz. Thus, by increasing the subcarrier spacing, the OFDM symbol duration decreases. Accordingly, it becomes possible to provide a frame structure suitable for low latency communications.

In NR, BWPs to which a different subcarrier spacing is set can be provided at the same time. Therefore, in NR, plural BWPs supporting different use cases can be provided at the same time.

### 2. Number of Active BWP

BWP that is capable of performing transmission and reception is also referred to as active BWP. The number of BWPs capable of performing transmission and reception at the same time is also referred to as the number of active BWP. The base station 100 has the plural number of active BWP of the is more than one. On the other hand, the number of active BWP of the terminal device 200 can be one. It is, of course, conceivable that the terminal device 200 that has the plural number of active BWP appears in future. These scenarios are shown in Table 1 below.

TABLE 1
Scenarios Relating to Number of Active BWPs

| Scenario | Active BWP |
|---|---|
| 3GPP Rel. 15 | A terminal device can use only one |
| | BWP at the same time. |
| Conceivable Future | A terminal device can use plural |
| Scenario | BWPs at the same time. |

In the technique according to the present disclosure, the number of active BWP of the terminal device 200 is assumed to be one.

### 3. Relation Between CC and BWP

In the present embodiment, explanation is given, focusing on plural BWPs. However, a method of antenna switching of the present disclosure described later is applicable to a case with plural component carriers (CCs). CC is an operating frequency band. It is conceivable that in most cases, an adjacent BWP is applied in practice. It is because an adjacent BWP is closer in frequency. Accordingly, a part explained as BWP in the present disclosure can be replaced with CC basically. It is assumed that plural BWPs can be used at the same time, and it is assumed also in the case of CC that plural CCs can be used at the same time.

### 4. Codebook-Based Beamforming

The base station 100 can improve, for example, the communication quality by performing communication with the terminal device 200 by performing beamforming. Beamforming methods include a method of generating a beam that follows the terminal device 200, and a method of selecting a beam that follows the terminal device 200 from among candidate beams. Because the former method needs calculation cost each time a beam is generated, it is less likely to be adopted into future wireless communication systems (for example, 5G). On the other hand, the latter method is also adopted into full dimension multiple input multiple output (FD-MIMO) of third generation partnership project (3GPP) release 13. The latter method is also referred to as codebook-based beam forming.

In the codebook-based beam forming, the base station 100 prepares (that is, generates) beams directed to various directions in advance, selects a beam suitable for the intended terminal device 200 from among the beams prepared in advance, and communicates with the terminal device 200 by using the selected beam. For example, the base station 100 prepares 360 kinds of beams every 1 degree when communication in 360 degrees in a horizontal direction is possible. To make beams to overlap each other in half, the base station 100 prepares 720 kinds of beams. As for a vertical direction, the base station 100 prepares beams of, for example, 180 degrees from −90 degrees to +90 degrees.

Note that because the terminal device 200 only observes a beam, there is no much necessity to be aware of existence of the codebook in the base station 100.

The plural beams prepared by the base station 100 in advance are also referred to as beam group in the following. The beam group can be defined, for example, for each frequency band. Moreover, the beam group can be defined for each Rx/Tx beam, or for each downlink/uplink.

### 5. Beam Sweeping

In NR, beam sweeping in which a measuring signal (known signal) is transmitted or received by using each of plural beams belonging to the beam group to select a most suitable beam to be used for communication is considered. The measuring signal is also referred to as reference signal in some cases. Based on a measurement result of the measuring signal transmitted while performing beam sweeping, a most suitable beam for transmission (hereinafter, also referred to as Tx beam) can be selected. One example th ereof will be explained, referring to FIG. 3.

FIG. 3 is a diagram for explaining about the beam sweeping. In the example illustrated in FIG. 3, the base station 100 transmits the measuring signal while performing beam sweeping (that is, while switching Tx beams) using a beam group 40. Hereinafter, transmission while performing beam sweeping will also be referred to as beam sweeping transmission. The terminal device 200 measures the beam-sweeping transmitted measuring signal, and determines which Tx beam is best receivable. Thus, the most suitable Tx beam of the base station 100 is selected. By performing a similar procedure, switching the base station 100 and the terminal device 200, the base station 100 can select the most suitable Tx beam of the terminal device 200.

On the other hand, a best receivable beam (hereinafter, also referred to as Rx beam) can be selected based on the measurement result obtained by receiving the measuring signal while performing beam sweeping. For example, the terminal device 200 transmits the measuring signal in an uplink. The base station 100 receives the measuring signal while performing beam sweeping (that is, while switching Rx beams), and determines which Rx beam is best receivable. By performing a similar procedure, switching the base station 100 and the terminal device 200, the terminal device 200 can select the most suitable Rx beam of the terminal device 200. Moreover, hereinafter, reception while performing beam sweeping will also be referred to as beam sweeping reception.

The one that receives and measures the beam-sweeping transmitted measuring signal notifies of a measurement result to the one that transmits the measuring signal. The measurement result includes information indicating which Tx beam is most suitable. The most suitable Tx beam is, for example, a Tx beam having the largest reception power. The measurement result may include information indicating one Tx beam having the largest reception power, or may include information indicating top K kinds of Tx beams having a large reception power. The measurement result includes information indicating identification information (for example, an index of the beam) of a Tx beam and a magnification of a reception power (for example, reference signal received power (RSRP)) of the Tx beam in an associated manner.

A beam for beam sweeping is transmitted giving a directivity to a reference signal, which is a known signal. Therefore, the terminal device 200 can distinguish the beam by a resource of the reference signal.

The base station 100 can provide one beam by using a resource of one reference signal. That is, when 10 resources are provided, the base station 100 can perform beam sweeping corresponding to 10 different directions. 10 resources can be called resource set collectively. On resource set constituted of 10 resources can provide beam sweeping corresponding to 10 directions.

### 6. CSI Acquisition Procedure

A channel state information (CSI) acquisition procedure is performed after a most suitable beam is selected by the beam selection procedure including the beam sweeping described above. By the CSI acquisition procedure, a channel quality in communication using the selected beam is acquired. For example, in the CSI acquisition procedure, a channel quality indicator (CQI) is acquired.

The channel quality is used to determine a communication parameter, such as a modulation method. If a modulation method by which only a small number of bits can be transmitted although the channel quality is high, for example, quadrature phase shift keying (QPSK), is adopted, throughput becomes low. On the other hand, a modulation method by which a large number of bits can be transmitted although the channel quality is low, for example, 256 quadrature amplitude modulation (QAM), is adopted, reception of data fails at the receiver side, and the throughput becomes low. As described, properly acquiring a channel quality is important for improvement of throughput.

FIG. 4 is a sequence diagram illustrating an example of a typical beam selection procedure and a CSI acquisition procedure performed by a base station and a terminal device. As illustrated in FIG. 4, the base station beam-sweeping transmits a measuring signal to select a beam (step S11). Subsequently, a terminal device performs measurement of the measuring signal to select a beam, and notifies of a measurement result of a beam (beam report) to the base station (step S12). The measurement result includes, for example, information indicating a selection result of a most suitable Tx beam of the base station. Next, the base station transmits a measuring signal for channel quality acquisition by using the selected most suitable beam (step S13). Subsequently, the terminal device notifies of a channel quality acquired based on the measurement result of the measuring signal to the base station (step S14). The base station transmits user data to the terminal device by using a communication parameter based on the informed channel quality (step S15). As above, for a beam report, the measurement result of the measuring signal for beam selection is transmitted to the terminal or the base station.

A channel quality of a downlink is measured based on a measuring signal transmitted by a downlink. On the other hand, the channel quality of a downlink can also be measured based on a measuring signal transmitted by an uplink. This is because an uplink channel and a downlink channel have reversibility, and the qualities of these channels are basically the same. Such reversibility is also referred to as channel reciprocity.

When a channel quality of a downlink is measured based on a measuring signal of a downlink, notification of a measurement result of a measuring signal for channel quality acquisition is performed as indicated at step S14 in FIG. 4. This notification of the measurement result can be a heavy overhead. A channel can be expressed by a matrix of N×M when the number of transmission antenna is M and the number of reception antenna is N. Each element of the matrix is to be a complex number corresponding to IQ. For example, when each I/Q is expressed by 10 bits, the number of transmission antenna is 100, and the number of reception antenna is 8, 8×100×2×10=16000 bits are used for notification of the measurement result of the channel quality, and it will be a heavy overhead.

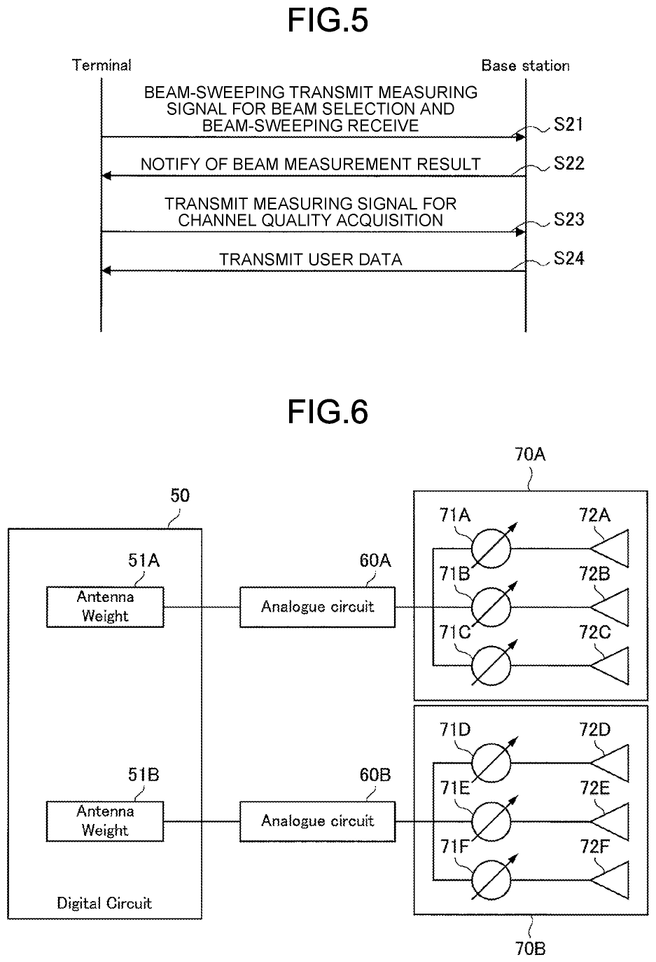

On the other hand, when the channel quality of a downlink is measured based on the measuring signal of an uplink, because a measurement subject is the base station, notification of a measurement result is not necessary. Therefore, by measuring a channel quality of a downlink based on a measuring signal of an uplink, an overhead relating to notification of a measurement result can be reduced, and a throughput can be improved. A flow of processing when a channel quality of a downlink is measured based on a measuring signal of an uplink will be explained, referring to FIG. 5

FIG. 5 is a sequence diagram illustrating another example of a flow of a typical beam selection procedure and a CSI acquisition procedure performed by a base station and a terminal device. As illustrated in FIG. 5, the terminal device beam-sweeping transmits a measuring signal for beam selection, and the base station receives the measuring signal while performing beam sweeping (step S21). At this time, the base station selects a most suitable Tx beam of the terminal device and a most suitable Rx beam of the base station based on the measurement result. Subsequently, the base station notifies of the measurement result (beam report) of a beam to the terminal device (step S22). The measurement result includes information indicating a selection result of a most suitable Tx beam of the terminal device. Next, the terminal device transmits a measuring signal for channel quality acquisition by using the selected Tx beam (step S23). The base station acquires a channel quality of an uplink based on the measurement result, and acquires a channel quality of a downlink based on the channel quality of an uplink. The base station transmits user data to the terminal device by using a communication parameter based on the acquired channel quality of the downlink (step S24). As above, for a beam report, the measurement result of the measuring signal for beam selection received by the base station or the terminal is transmitted to the terminal or the base station.

### 7. Analog-Digital-Hybrid Antenna Architecture

To control the directivity of an antenna, an architecture in which all of processing is performed by an analog circuit can be considered. Such an architecture is also referred to as full digital architecture. In the full digital architecture, the same number of antenna weight as that of antenna (that is, antenna device) is applied in a digital region (that is, by a digital circuit) to control the directivity of an antenna. The antenna weight is a weight to control an amplitude and a phase. However, in the full digital architecture, there is a disadvantage that the digital circuit becomes large. As an architecture that solves the disadvantage of the full digital architecture, an analog-digital-hybrid antenna architecture is available.

FIG. 6 is a diagram for explaining an example of an analog-digital-hybrid antenna architecture. The architecture illustrated in FIG. 6 includes a digital circuit 50, an analog circuit 60 (60A and 60B), and an antenna panel 70 (70A and 70B). The digital circuit can apply plural antenna weights 51 (51A and 51B). The analog circuit 60 and the antenna panel 70 are provided in the same number as the number of the antenna weights 51 applicable in the digital circuit 50. In the antenna panel 70, plural antennas 72 (72A to 72F), and phase shifters 71 (71A to 71F) in the same number as the number of antennas 72 are provided. The phase shifter 71 is a device that applies an antenna weight capable of controlling only a phase in an analog region.

The properties of the antenna weight in the digital region and the antenna weight in the analog region are shown in Table 2 below.

TABLE 2
Properties of Antenna Weight in Digital Region
and Antenna Weight in Analog Region

| | Analog Region | Digital Region |
|---|---|---|
| What is Controlled | Phase | Amplitude and Phase |
| Analog or Digital | Analog | Digital |
| Application | Time Region | In OFDM modulation, |
| Position is in Time | | it is applied in a |
| Region or Frequency | | frequency region |
| Region | | before FFT on a |
| | | transmission side, |
| | | and is applied in a |
| | | frequency region |
| | | after IFFT on a |
| | | reception side. |
| Whether Different | Impossible | Possible |
| Beams can be | | |
| Provided in | | |
| Different Frequency | | |
| Resource of Same | | |
| Time Resources | | |

The antenna weight in the digital region is applied in a frequency region when an orthogonal frequency division multiplexing (OFDM) modulation is used. For example, the antenna weight in the digital region is applied before inverse fast Fourier transform (IFFT) at the time of transmission, and is applied after fast Fourier transform (FFT) at the time of reception.

The antenna weight in the digital region is applied in a frequency region. Therefore, by applying the antenna weight of the digital region, beams can be transmitted to different directions by using different frequency resources even in the same time resource. On the other hand, the antenna weight in the analog region is applied in a time region. Therefore, even if the antenna weight of the analog region is applied, beams can only be transmitted to the same direction throughout the entire frequency resources in the same time resource.

That is, beams can be transmitted to different directions by using different frequency resources, even in the same time resource. On the other hand, a single unit of the antenna panel 70 can direct a beam only to one direction by using the same time resource and frequency resource. Accordingly, in the analog-digital-hybrid antenna architecture, directions in which beams can be transmitted and received in the same time resource corresponds to the number of the antenna panel 70. Furthermore, in the analog-digital-hybrid antenna architecture, the number of beam group that can be beam-sweeping transmitted and beam-sweeping received in the same time resource corresponds to the number of the antenna panel 70.

The analog-digital-hybrid antenna architecture as described above can be used for both the base station 100 and the terminal device 200.

### 8. Antenna Panel

In FIG. 6, a phase shifter of three analog regions are connected to a weight of a single digital region. A set of this weight of a single digital region and the phase shifter of the three analog regions can be arranged together as an antenna panel. What is shown in FIG. 6 is an example when three antenna devices constitute an antenna panel, and two units of this antenna panel are provided. It has been explained in Table 2, but a beam of a different direction cannot be generated using a different frequency in the same time normally with only one panel. However, if two panels are used, beams of different directions can be generated even in the same time. This configuration of antenna panel is used both in the base station and the terminal.

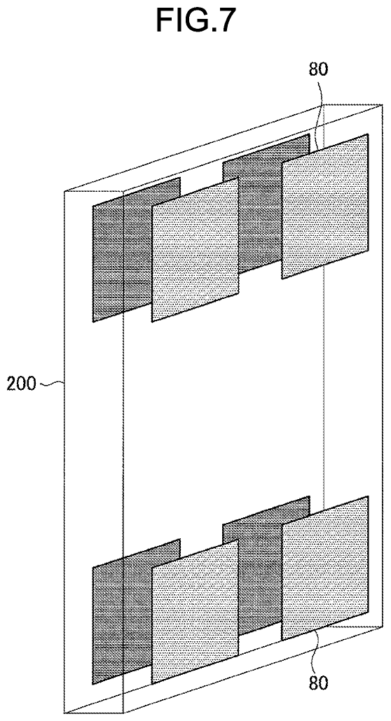

FIG. 7 is an explanatory diagram illustrating an example in which eight antenna panels are arranged in the terminal device 200. In FIG. 7, an example in which a total of eight units, four units each on a front surface and a rear surface of the terminal device 200, of the antenna panels are arranged is illustrated. Although the number of antenna devices mounted on one antenna panel is not limited to a specific number but, for example, four pieces of antenna devices are mounted on one antenna panel.

### 9. Reference Signal and Resource of User Data

To perform the beam sweeping and the CSI acquisition procedure, transmission and reception of a reference signal between the base station device 100 and the terminal device 200 is necessary. Moreover, also when user data is transmitted and received between the base station device 100 and the terminal device 200, transmission and reception of a reference signal is necessary. These reference signals are basically specified by resources of a frequency and a time, and some cases in which a resource is specified by using an orthogonal sequence are included also. On the other hand, for the user data, a schedular included in a control signal specifies a resource of a frequency and a time of the user data. In a case of the user data, an orthogonal sequence is not to be assigned as a resource, but only resources of a frequency and a time.

TABLE 3
About Resources of Respective Signals

| | | Downlink | |
|---|---|---|---|
| | Reference | Control | |
| | signal | signal | User Data |
| Resource | Frequency, | Frequency, | Frequency, |
| type | time, sequence | time | time |
| Allocation | RRC | Static (head | Downlink |
| method | Signaling | of a slot) | control |
| | (semi-static), | | signal |
| | DCI (Dynamic) | | |

### 10. Antenna Panel on Reception Side and Selection of Beam

### 10-1 Antenna Panel in Beam Management Stage and Selection of Beam

During beam management, it is determined with which beam of which antenna panel a beam coming from the base station 100 should be received in the terminal device 200 by try and error. Because different antenna panels can operate at the same time basically, for example, when four resources are configured to as a resource for a reference signal for the same beam for a downlink beam, the terminal device 200 can apply four different reception beams for the respective antenna panels, and thereby determine which is a preferable reception beam. This operation is performed the same number times as the number of downlink beams corresponding to different directions in the base station 100. When the number of downlink beams is 10, by observing reception beams of the terminal device 200 using 10×4=40 resources, the terminal device 200 can determine a preferable beam from the base station 100 and an antenna panel and a preferable beam in the terminal device 200.

### 10-2. Selection of Antenna Panel and Beam in Stage of CSI Procedure

A stage of the CSI procedure is a stage of checking a quality of a channel more precisely by using precoding (more detailed antenna control) for transmission in the base station 100. In the stage of the CSI procedure, reception of a reference signal for CSI procedure is performed with the antenna panel of the terminal device 200 identified in the stage of the previous beam management and the beam that has been determined to be most preferable among the antenna panels.

### 11. Multiple Base Station

It has so far been supposed that plural antenna panels are mounted on a single unit of the base station 100. However, a case in which plural units of the base stations 100 are arranged around the terminal device 200 is also conceivable. The terminal device 200 needs to acquire synchronization with plural antennas of the plural terminal devices 200 (multiple base stations). This synchronization includes both frequency synchronization and time synchronization. The multiple base station in this case is assumed to have the same cell ID. Therefore, it seems to be the same cell from the terminal device 200, but actual signal transmission and reception are performed physically by different units of the base stations 100.

### 12. Beam Recovery

Beam recovery is to search a new different beam by the terminal device 200 to use when a beam between the base station 100 and the terminal device 200 becomes unusable for some reason (blocking by a car, a human, a building, and the like). The reasons why the beam recovery are necessary is mostly as follows.

First, it is recovery from a state in which a beam is unusable because of blocking. A state in which a control signal or user data cannot be communicated between the base station 100 and the terminal device 200 because a beam is blocked when a car, a human, a building, or the like enters between the base station 100 and the terminal device 200 is blocking.

Next, recovery from a state in which a beam is unusable by an interference. That is a state in which an intended signal cannot be transmitted and received between the base station 100 and the terminal device 200 as a signal from another unit of the base station 100 to another unit of the terminal device 200 interferes.

Because a signal completely disappears when the blocking occurs, recovery with the same beam cannot be expected until a car or a human being the obstacle is removed. Even if a frequency to transmit data is changed a little, it is highly possible that beam transmission and reception using an entire adjacent frequency band in the direction is disabled. Moreover, in the time direction also, it is highly possible that communication is disabled for several seconds until the obstacle is removed.

On the other hand, the interference does not occur in all of time and frequency resources, but it stops when the other base station 100 or the other terminal device 200 stops transmission. Unlike LTE in which a control signal or user data is provided by a single beam, when a control signal or user data is transmitted or received by plural beams, improvement in tolerance to interference considering this characteristic is needed. On the other hand, for the blocking, basically, it is necessary to change the beam. To change the beam, swift recovery, that is, to identify a new beam in short time, is demanded. This is because, continuous low-delay communication is required depending on an application as in a control of a car, a control of a drone, a control of a remove medical device, and the like.

From the above viewpoints, a method of performing effective recovery of plural beam links is needed. Furthermore, because the number of links to perform maintenance of beam varies according to an internal condition of the terminal device 200, it has been inefficient to repeat beam recovery to perform maintenance on the same number of beam links uniformly.

### 2. CONFIGURATION EXAMPLE

### 2.1. Configuration Example of Base Station

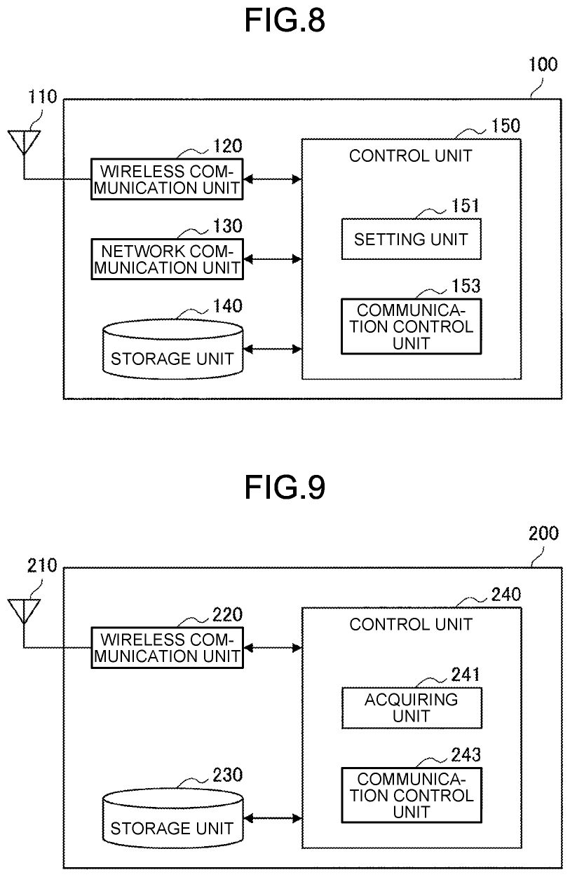

FIG. 8 is a block diagram illustrating an example of a configuration of the base station 100 according to the present embodiment. Referring to FIG. 8, the base station 100 includes an antenna unit 110, a wireless communication unit 120, a network communication unit 130, a storage unit 140, and a control unit 150.

### 1. Antenna Unit 110

The antenna unit 110 radiates a signal output by the wireless communication unit 120 into the air as a radio wave. Moreover, the antenna unit 110 converts a radio wave in the air into a signal, and outputs the signal to the wireless communication unit 120.

Particularly in the present embodiment, the antenna unit 110 includes plural antenna devices, and can form a beam.

### 2. Wireless Communication Unit 120

The wireless communication unit 120 transmits and receives a signal. For example, the wireless communication unit 120 transmits a downlink signal to a terminal device, and receives an uplink signal from a terminal device.

Particularly in the present embodiment, the wireless communication unit 120 can communicate with a terminal device, forming plural beams by the antenna unit 110.

In the present embodiment, the antenna unit 110 and the wireless communication unit 120 are constituted of plural units of the antenna panels 70 of the analog-digital-hybrid architecture explained above with reference to FIG. 6. For example, the antenna unit 110 corresponds to the antenna 72. Moreover, for example, the wireless communication unit 120 corresponds to the digital circuit 50, the analog circuit 60, and the phase shifter 71.

### 3. Network Communication Unit 130

The network communication unit 130 transmits and receives information. For example, the network communication unit 130 transmits information to another node, and receives information from the other node. For example, the other node described above includes another base station and core network node.

### 4. Storage Unit 140

The storage unit 140 temporarily or permanently stores a program for operation of the base station 100 and various kinds of data.

### 5. Control Unit 150

The control unit 150 controls an overall operation of the base station 100, and provides various functions of the base station 100. In the present embodiment, the control unit 150 includes a setting unit 151 and a communication control unit 153.

The setting unit 151 performs various settings relating to wireless communication between the base station 100 and the terminal device 200. Particularly in the present embodiment, the setting unit 151 performs various settings to efficiently measure a synchronization signal from the base station 100 in the terminal device 200. The communication control unit 153 performs communication control processing to output a signal from the wireless communication unit 120 based on the settings by the setting unit 151.

The control unit 150 can further include other components other than these components. That is, the control unit 150 can perform an operation other than the operation of these components.

### 2.2. Configuration Example of Terminal Device

FIG. 9 is a block diagram illustrating an example of a configuration of the terminal device 200 according to the present embodiment. Referring to FIG. 9, the terminal device 200 includes an antenna unit 210, a wireless communication unit 220, a storage unit 230, and a control unit 240.

### 1. Antenna Unit 210

The antenna unit 210 radiates a signal output by the wireless communication unit 220 into the air as a radio wave. Moreover, the antenna unit 210 converts a radio wave in the air into a signal, and outputs the signal to the wireless communication unit 220.

Particularly in the present embodiment, the antenna unit 210 includes plural antenna devices, and can form a beam.

### 2. Wireless Communication Unit 220

The wireless communication unit 220 transmits and receives a signal. For example, the wireless communication unit 220 receives a downlink signal from the base station, and receives an uplink signal to the base station.

Particularly in the present embodiment, the wireless communication unit 220 can communicate with a base station, forming plural beams by the antenna unit 210.

In the present embodiment, the antenna unit 210 and the wireless communication unit 220 are constituted of plural units of the antenna panels 70 of the analog-digital-hybrid architecture explained above with reference to FIG. 6. For example, the antenna unit 110 corresponds to the antenna 72. Moreover, for example, the wireless communication unit 220 corresponds to the digital circuit 50, the analog circuit 60, and the phase shifter 71.

### 3. Storage Unit 230

The storage unit 230 temporarily or permanently stores a program for operation of the terminal device 200 and various kinds of data.

### 4. Control Unit 240

The control unit 240 controls an overall operation of the terminal device 200, and provides various functions of the terminal device 200. In the present embodiment, the control unit 240 includes an acquiring unit 241 and a communication control unit 243.

The acquiring unit 241 acquires information transmitted from the base station 100 by wireless communication between the base station 100 and the terminal device 200. Particularly in the present embodiment, the acquiring unit 241 acquires various kinds of information to efficiently measure a synchronization signal from the base station 100 in the terminal device 200. The communication control unit 243 performs communication control processing to output a signal from the wireless communication unit 220 based on the information acquired by the acquiring unit 241.

The control unit 240 can further include other components other than these components. That is, the control unit 240 can perform an operation other than the operation of these components.

### 3. FIRST EMBODIMENT

There is a case in which plural beam links subjected to maintenance at the same time becomes impossible to be maintained because of the terminal device 200. For example, because of a reason, such as temperature increase caused by calculation load of an application executed by the terminal device 200, a request for reducing the number of beam links can be issued. In this case, it is necessary to determine how to notify of it from the terminal device 200 to a network side.

In the present embodiment, the terminal device 200 specifies a beam link to be suspended by using a beam link ID that is mapped one to one correspondence with a beam report. Moreover, in the present embodiment, the terminal device 200 notifies the maximum number of beam links on which maintenance is to be performed with the beam report. The terminal device 200 may notifies of this maximum number of beam links per bandwidth part.

A specific example will be described. When the number of beams on which maintenance (in the present embodiment, operation of the terminal device 200 keeping selecting a most suitable beam) is performed is three, and when a request of reducing the number is issued in the terminal device 200, the terminal device 200 reduces the maximum number in a report to two, and specifies which beam link is to be suspended, for the beam report. This specification is not necessarily be made to a beam link in the report. This is because a beam link in a beam report that declares reduction of beam links is not necessarily a beam link intended to be excluded although the number of beam links is desired to be reduced urgently.

Hereinafter, an example including the maximum number of reports and specification of a beam link intended to be suspended will be described together with contents of a conventional beam report.

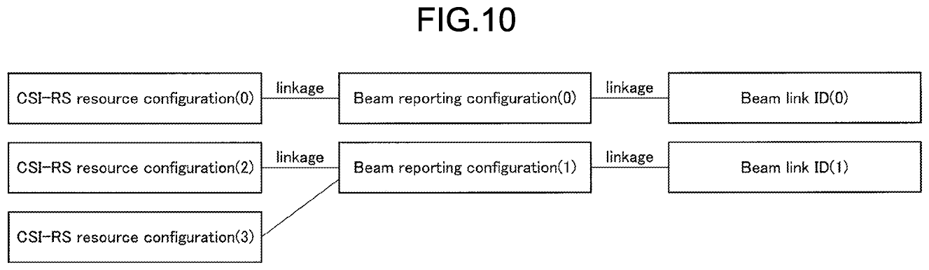

FIG. 10 is an explanatory diagram illustrating an example of linkage between a beam report and a beam link. AS illustrated in FIG. 10, a beam link ID is identified by one to one mapping with a beam reporting configuration. The terminal device 200 specifies a beam link for which maintenance is suspended as a stop beam link ID (SBI) by using the beam link ID defined herein.

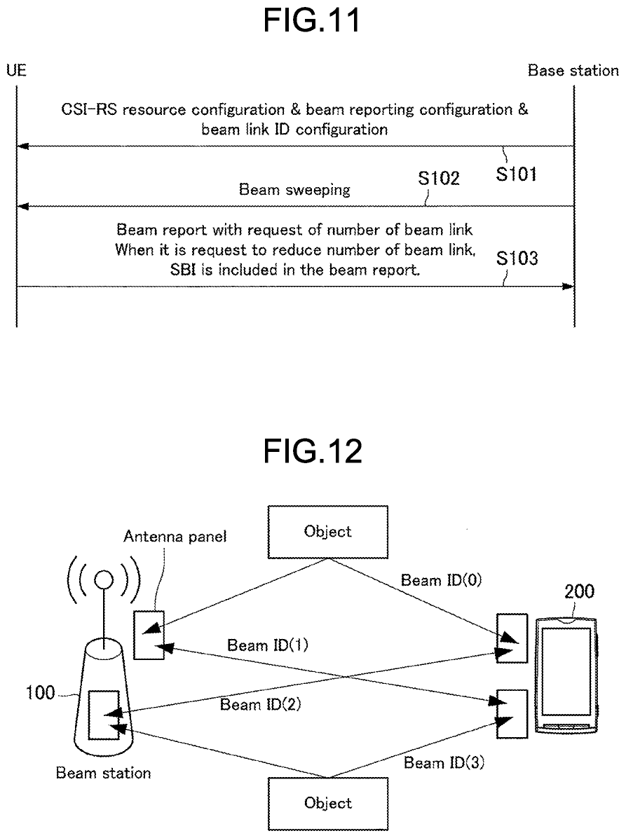

FIG. 11 is a flowchart illustrating an example of operations of the base station 100 and the terminal device 200 according to the present embodiment. The base station 100 sets a configuration of a CSI-RS resource, a configuration of a beam report, and a configuration of a beam link ID to the terminal device 200 (step S101).

Thereafter, the base station 100 performs beam sweeping (step S102). The terminal device 200 performs report to a beam radiated from the base station 100 (step S103). At this time, when a necessity to reduce the number of beams to be reported occurs, the terminal device 200 specifies a beam link for which a maintenance is suspended as an SBI by using the beam link ID.

TABLE 4
Example of Reducing Number of Beam Links in
Beam Report

| | |
|---|---|
| CRS (CSI-RS Resource | Specification of Beam Among Set |
| Index) | Plural Beams. Select from among |
| | beams corresponding to CSI-RS |
| | resource to which Report |
| | Configuration is Linked (3GPP |
| | TS38.214). |
| RSRP (Reference | Reception Power of Beam Selected |
| Signal Received | by CRI (3GPP TS38.214) |
| Power) | |
| SBI (Stop Beam Link | Beam Link for Which Maintenance |
| ID) | is Suspended out of Beam Links |
| It is Possible to | Identified by Configuration ID of |
| Report Plural SBIs | Beam Report |
| (When Desired to | |
| Reduce from 3 to 1) | |
| Maximum Beam Link | e.g. when Changing from 3 to 2, 2 |
| | is Specified |

The notification of the number of maximum beam links is of a beam link corresponding to a CSI-RS configuration associated with a beam link ID. When this CSI-RS configuration is set per band width part, it is natural to perform this notification of the number of maximum beam links per band width part.

By performing the operation as described above, the terminal device 200 can reduce the number of beam links to be subjected to maintenance for its own reason and, for example, the terminal device 200 becomes possible to decrease heat of its own device in a situation in which the temperature of its own device is high, by reducing the number of beam links to be subjected to maintenance. Moreover, for example, the terminal device 200 becomes possible to reduced power consumption in a situation in which power consumption of its own device increases and a battery charge remaining amount is equal to or lower than a predetermined value, by reducing the number of beam links to be subjected to maintenance.

A resource for recovery of a beam link allocated to the terminal device 200 is a resource to notify a beam link failure by random access. The terminal device 200 may notify of increase and decrease in the number of beam links to the base station 100 by using this random access procedure when a change in the number of maximum beam links occurs. Particularly, a request for increasing the number of maximum beam links is a request for increasing from two to three, similarly to increasing from zero to one in beam recovery and, therefore, it is compatible with making a request by using a random access resource for beam link recovery, that is a message portion following a preamble of a sequence portion. That is, at step S103 in FIG. 11, the terminal device 200 may notify of increase and decrease in the number of maximum beam links to the base station 100 by using the message portion following the preamble of the sequence portion. Table 5 is a table showing an example of contents of information stored in the message portion.

TABLE 5
Contents of Message Portion in Random Access

| Beam Recovery Request | |
|---|---|
| Increase and Decrease in | e.g. 1, 2, 3, . . . , N |
| Number of Maximum Beam Links | |

By notifying the number of maximum beam maintenance using the random access resource, it is possible to reduce the number of maintenances swiftly when the temperature of the terminal device 200 becomes high, or the like.

### 4. SECOND EMBODIMENT

When a beam link failure occurs once, even if the terminal device 200 transmits a message of the beam link failure and a recovery request by the random access resource using the same beam, the message can fail to be delivered to the base station 100 because the beam is blocked.

Therefore, in the present embodiment, the terminal device 200 receives settings of priority of transmission beams used for the beam recovery request from a network, and operates according to the priority of a beam. Moreover, in the present embodiment, the terminal device 200 may operate to transmit a beam recovery request by a random access resource in a beam different from a beam that has detected the beam link failure. This different beam may be two or more. The terminal device 200 may performs a beam recovery request for more than one beam link failure collectively as a single message in a single random access resource. Furthermore, as for a beam recovery request sent in a single message for beam link failures detected within how long period, a threshold of time may be set in the terminal device 200 from a network, and the terminal device 200 may operate according to the setting. Moreover, the terminal device 200 may transmit a beam recovery request by a single random access resource that is used for detection of two or more beam link failures.

A specific example will be described. For example, when the terminal device 200 detects a beam link failure in N beams, the terminal device 200 should transmit a beam recovery request for the beam link failure by using random access using a beam that is a different beam from the beam in which the beam link failure occurs to the base station 100. Selection of the different beam can be performed by implementation to the terminal device 200, but there has been no way for the terminal device 200 to learn whether the beam itself used in the implementation has not failed to establish a link.

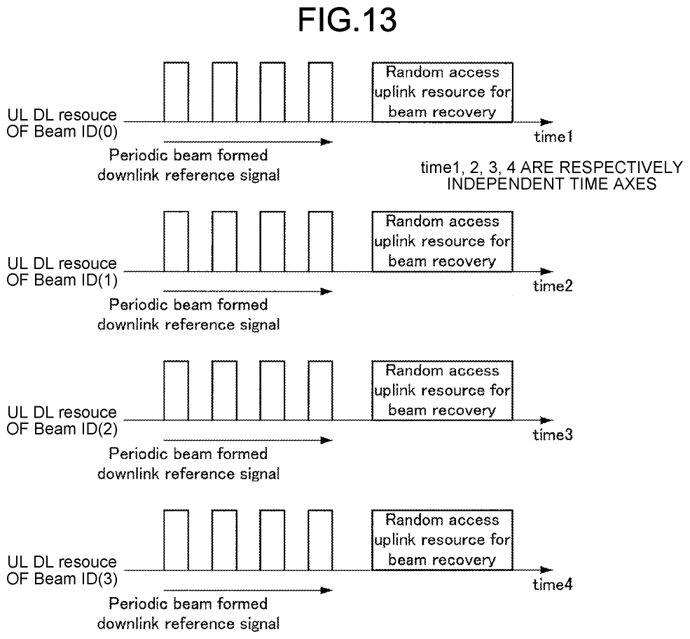

Therefore, in the present embodiment, a resource to monitor a beam link failure is provided for each beam, to determine whether a link failure has occurred per beam. FIG. 12 is an explanatory diagram indicating about a beam between the base station 100 and the terminal device 200. FIG. 13 is an explanatory diagram illustrating a state in which a resource to monitor a beam link failure is provided per beam.

Furthermore, the terminal device 200 needs to send a beam recovery request soon after a beam link failure is detected. Therefore, it is necessary to prepare a random access resource for the beam recovery request for each resource for beam link failure detection as illustrated in FIG. 13. Although it seems that four resources for beam link failure detection and a resource for beam recovery request are present at the same time in FIG. 13, these four resources are arranged at different times. This is because it is also a reason for preparing four resources for random access.

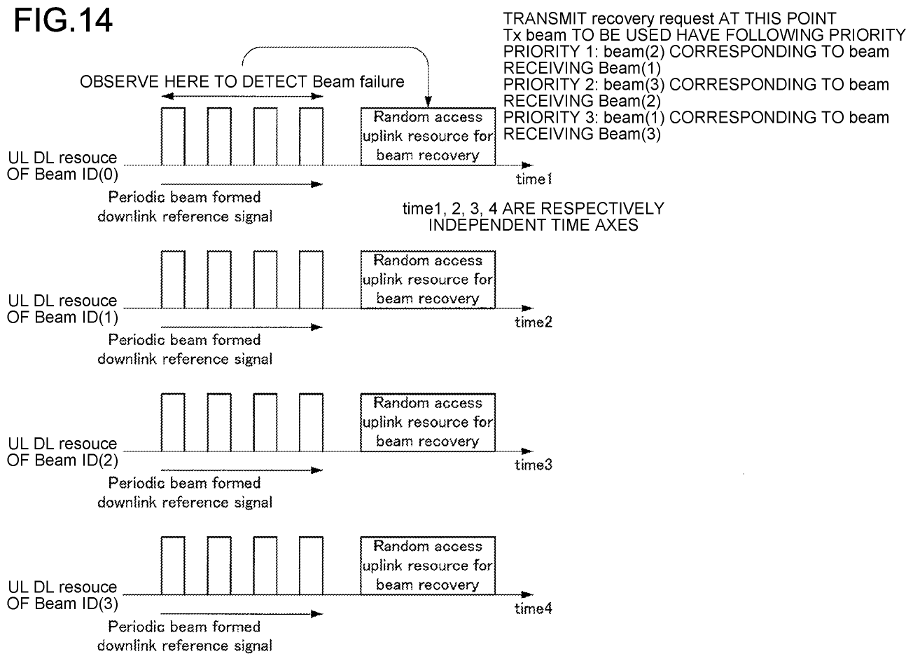

The terminal device 200 that has detected a beam link failure transmits a beam recovery request with a resource of uplink random access that is linked to the failed beam. The beam that is used by the terminal device 200 is one that has been set by the base station 100, and the terminal device 200 performs transmission by using the beam thus set. FIG. 14 is an explanatory diagram illustrating a beam recovery request by the terminal device 200. It is needless to say that a beam in which beam link failure has occurred cannot be used even if it is a beam of high priority. This setting is done for each beam link. FIG. 14 illustrates only setting of a beam link, the beam ID of which is 0.

Thus, the terminal device 200 can send a beam recovery request by using an appropriate beam, and can deliver a notification of the beam recovery request to the network certainly.

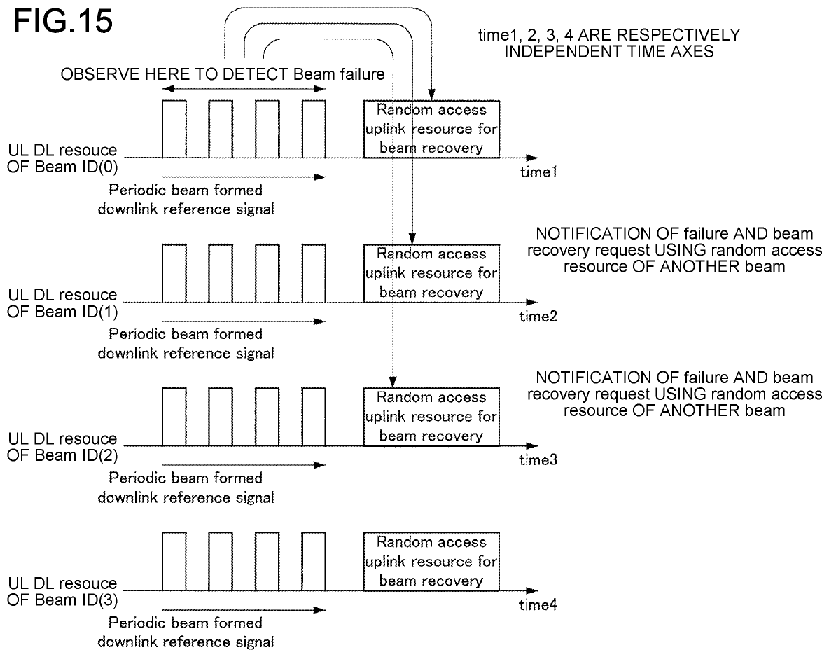

The terminal device 200 makes a beam recovery request by using random access resources of plural beams when a beam link failure occurs in a beam using user data for which particularly quick recovery is demanded, such as ultra-reliable and low latency communications (URLLC). FIG. 15 is an explanatory diagram illustrating a state in which the terminal device 200 makes a beam recovery request by using random access resources of plural beams. By making a beam recovery request by using random access resources of plural beams, the terminal device 200 can perform notification to the base station 100 certainly. It is because random access resources can collide with an uplink signal of the other terminal device 200.

As described, by making a beam recovery request by using random access resources of plural beams, it is particularly effective when a beam recovery request can fail because of contention.

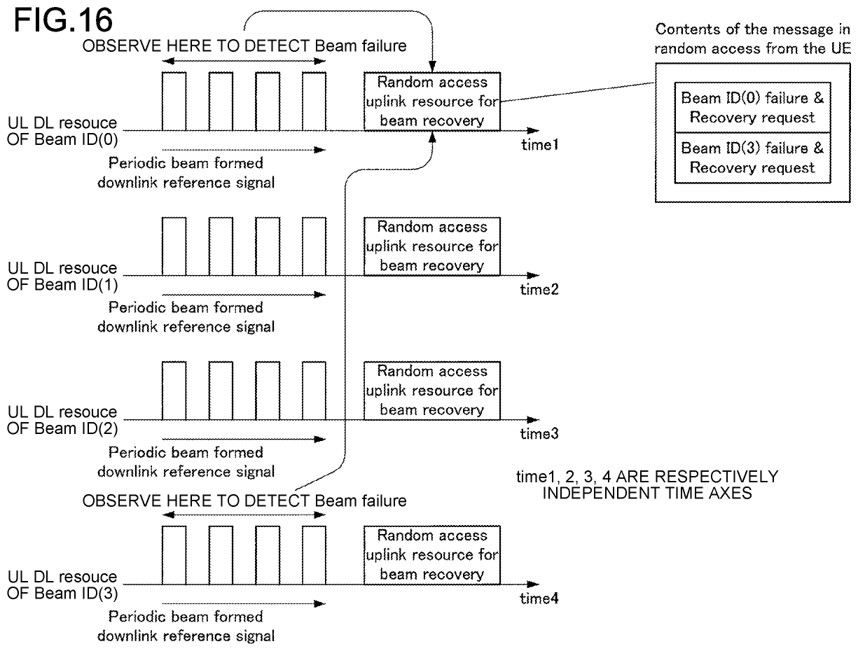

The terminal device 200 can include plural beam recovery requests in a single notification. The terminal device 200 can transmit M pieces of beam recovery requests at the same time when beam link failures occur in M beams at the same time. FIG. 16 is an explanatory diagram illustrating a state in which the terminal device 200 transmits plural beam recovery requests at the same time.

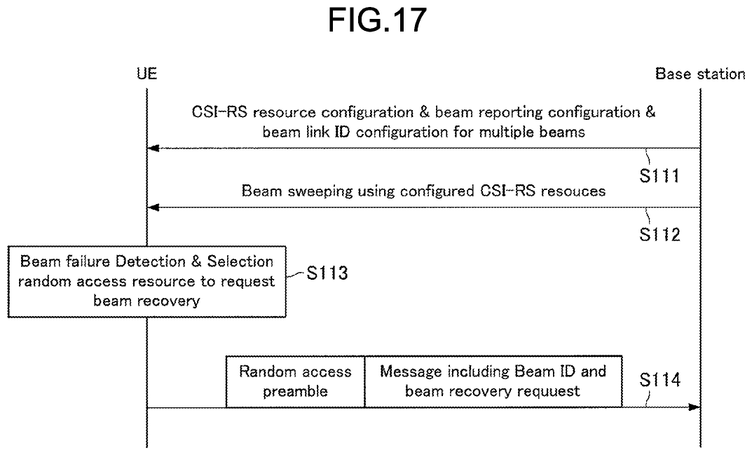

FIG. 17 is a flowchart illustrating an example of operations of the base station 100 and the terminal device 200 according to the present embodiment. The base station 100 sets a configuration of the CSI-RS resource, a configuration of the beam report, and a configuration of the beam link ID to the terminal device 200 (step S111).

Thereafter, the base station 100 performs beam sweeping (step S112). The terminal device 200 detects a beam link failure, and selects a random access resource to transmit a beam recovery request (step S113). The terminal device 200 then transmits the beam recovery request by using the selected random access resource (step S114). At this time, the terminal device 200 transmits the beam ID for which the beam link failure is detected and the request for recovery by using the random access resource for beam link recovery, that is, the message portion following the preamble of the sequence portion.

By thus operating, it is possible to reduce the possibility of occurrence of collision in random access, and the beam recovery request can be delivered to network certainly from the terminal device 200 to the base station 100.

There is a case in which two or more beam links fail at the same time by blocking. In such a case, if the beam recovery request is transmitted individually from the terminal device 200, there is a possibility that resources become short because of the random access. Moreover, there is a case in which the references signals of downlink for beam sweeping cannot be allocated for plural beam recovery requests at the same time. For example, it is unlikely to be in short of resources for recovery of 2 beams, but in the case of performing recovery of 10 beams at the same time, downlink and uplink frequency resources and time resources can be in short.

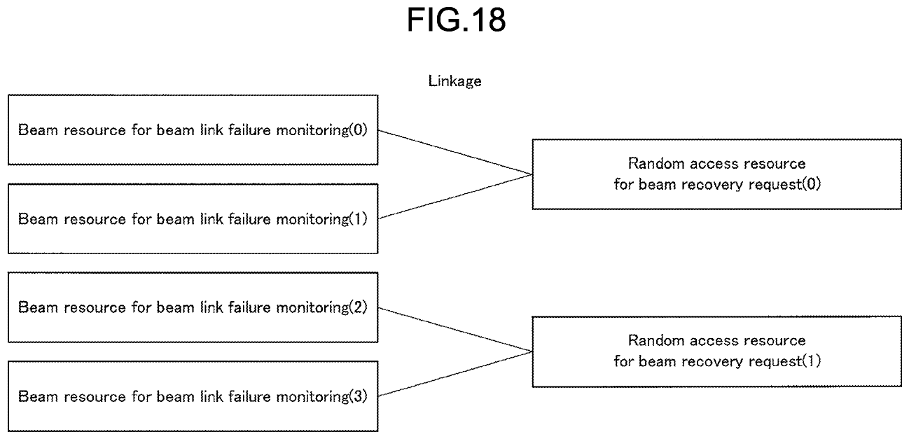

Therefore, in the present embodiment, the terminal device 200 may transmit plural beam recovery requests with a single random access resource. FIG. 18 is an explanatory diagram illustrating a state in which the terminal device 200 transmits plural beam recovery requests with a single random access resource. By thus transmitting plural beam recovery requests with a single random access resource, it is possible to reduce times of random access by the terminal device 200.

Furthermore, in this case, the random access resource is not provided per beam link, but a common resource is provided. By providing a common resource at the time of transmitting plural beam recovery requests with one random access resource, the resources for random access can be reduced.

Linkage between a resource for beam sweeping to observe beam link failures and a random access resource to transmit a beam recovery request corresponding thereto is set to a terminal from a network in advance. In FIG. 18, when a beam link (0) fails to establish a link, or a link failed to be established by beam link (1) fails, a resource of number 0 (random access resource for beam recovery request (0)) is used. When times of link failures are almost the same time, it is possible to include plural beam recovery requests in a single message as illustrated in FIG. 16. A threshold for this time may be set in advance to the terminal device 200 from a network.

Thus, an overhead in uplink of the terminal device 200 can be reduced. Therefore, an effect of improving the throughput of the terminal device 200 in uplink can be obtained.

### 5. APPLICATION

The technique according to the present disclosure can be applied to various products.

For example, the base station 100 may be implemented as any kind of evolved node B (eNB), such as a macro eNB and a small eNB. The small eNB may be an eNB that covers a cell smaller than a microcell, such as a pico eNB, a micro eNB, or a home (femto) eNB. Alternatively, the base station 100 may be implemented as other types of base stations, such as a node B or a base transceiver station (BTS). The base station 100 may include a main unit (also called base station device) that controls wireless communication, and one or more units of remote radio heads (RRHs) that are arranged at a different place from the main unit. Moreover, various kinds of terminals described later may operate as the base station 100 by temporarily or semipermanently performing base station functions.

Furthermore, for example, the terminal device 200 may be implemented as a mobile terminal, such as a smartphone, a tablet personal computer (PC), a laptop PC, a mobile game terminal, a portable/dongle mobile router, or a digital camera, or as an in-car terminal, such as a car navigation device. Moreover, the terminal device 200 may be implemented as a terminal that performs machine to machine (M2M) communications (also called machine type communication (MTC) terminal). Furthermore, the terminal device 200 may be a wireless communication module (for example, an integrated circuit module constituted of one die) that is mounted on these terminals.

### 5.1. Application Relating to Base Station

### First Application

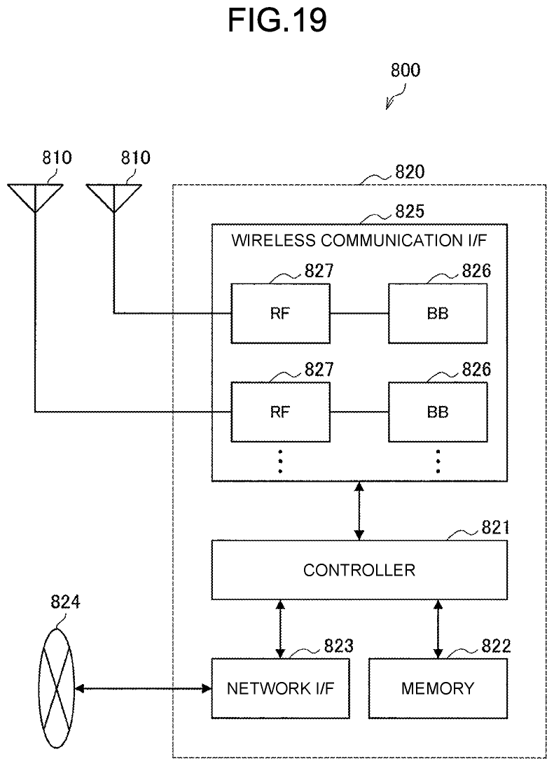

FIG. 19 is a block diagram illustrating a first example of a schematic configuration of eNB to which the technique according to the present disclosure can be applied. An eNB 800 includes one or more antennas 810 and a base station device 820. Each of the antennas 810 and the base station device 820 can be connected to each other through an RF cable.

Each of the antennas 810 includes a single or plural antenna devices (for example, plural antenna devices constituting a MIMO antenna), and is used for transmission and reception of a wireless signal by the base station device 820. The eNB 800 includes the plural antennas 810 as illustrate in FIG. 19 and, for example, the plural antennas 810 may respectively correspond to plural frequency bands used by the eNB 800. Although an example in which the eNB 800 includes plural units of the antennas 810 has been illustrated in FIG. 19, the eNB 800 may include a single unit of the antenna 810.

The base station device 820 includes a controller 821, a memory 822, a network interface 823, and a wireless communication interface 825.

The controller 821 may be, for example, a CPU or a DSP, and controls to operate various functions of higher layers of the base station device 820. For example, the controller 821 generates a data packet from data in a signal processed by the wireless communication interface 825, and transfers the generated packet through the network interface 823. The controller 821 may generate a bundled packet by bundling data from plural baseband processors, and may transfer the generated bundled packet. Moreover, the controller 821 may have logical functions to perform controls, such as a radio resource control, a radio bearer control, mobility management, an admission control, or scheduling. Furthermore, the controls may be performed in cooperation with a peripheral eNB or a core network node. The memory 822 includes a RAM and a ROM, and stores a program that is executed by the controller 821, and various kinds of control data (for example, a terminal list, transmission power data, scheduling data, and the like).

The network interface 823 is a communication interface to connect the base station device 820 to a core network 824. The controller 821 may communicate with a core network node or another eNB through the network interface 823. In this case, the eNB 800 and the core network node or the other eNB may be connected to each other by a logical interface (for example, an S1 interface or an X2 interface). The network interface 823 may be a wired communication interface, or a wireless communication interface for wireless back hole. When the network interface 823 is a wireless communication interface, the network interface 823 may use a frequency band higher than a frequency band used by the wireless communication interface 825, for the wireless communication.

The wireless communication interface 825 supports any of cellular communication methods, such as long term evolution (LTE) or LTE-Advanced, and provides wireless connection to a terminal positioned in a cell of the eNB 800 through the antenna 810. The wireless communication interface 825 can include, typically, a baseband (BB) processor 826, an RF circuit 827, and the like. The BB processor 826 may perform, for example, encoding/decoding, modulation/demodulation, and multiplexing/demultiplexing, and the like, and performs various signal processing of each layer (for example, L1, medium access control (MAC), radio link control (RLC), and packet data convergence protocol (PDCP)). The BB processor 826 may have some of or all of the logical functions described above, in place of the controller 821. The BB processor 826 may be a memory that stores a communication control program, or a module including a processor that executes the program and a related circuit, and functions of the BB processor 826 may be variable according to an update of the program described above. Moreover, the module described above may be a card or a blade inserted into a slot of the base station device 820, or may be a chip mounted on the card described above or the blade described above. On the other hand, the RF circuit 827 may include a mixer, a filter, an amplifier, and the like, and transmits and receives a wireless signal through the antenna 810.

The wireless communication interface 825 includes plural units of the BB processors 826 as illustrated in FIG. 19, and the plural BB processors 826 may respectively correspond, for example, to respective plural frequency bands used by the eNB 800. Moreover, the wireless communication interface 825 includes plural units of the RF circuits 827 as illustrated in FIG. 19, and the plural RF circuits 827 may respectively correspond, for example, to the respective antenna devices. Although an example in which the wireless communication interface 825 includes plural units of the BB processors 826 and plural units of the RF circuits 827 is illustrated in FIG. 19, the wireless communication interface 825 may include a single unit of the BB processor 826 or a single unit of the RF circuit 827.

In the eNB 800 illustrated in FIG. 19, at least one of the components (the setting unit 151, and/or the communication control unit 153) included in the control unit 150 explained with reference to FIG. 8 may be contained in the wireless communication interface 825. Alternatively, at least a part of these components may be contained in the controller 821. As an example, the eNB 800 may have a module including a part or all of the wireless communication interface 825 (for example, the BB processor 826), and/or the controller 821 mounted therein, and at least one of the components described above may be implemented in the module. In this case, the module described above may store a program to cause a processor to function as at least one of the components described above (in other words, a program to cause the processor to perform an operation of at least one of the components described above), and may execute the program. As another example, a program to cause the processor to function as at least one of the components described above may be installed in the eNB 800, and the wireless communication interface 825 (for example, the BB processor 826) and/or the controller 821 may execute the program. As described above, the eNB 800, the base station device 820, or the module described above may be provided as a device that has at least one of the components described above, and a program to cause the processor to function as at least one of the components described above may be provided. Furthermore, a readable recording medium that stores the program described above may be provided.

Moreover, in the eNB 800 illustrated in FIG. 19, the wireless communication unit 120 explained with reference to FIG. 10 may be implemented in the wireless communication interface 825 (for example, the RF circuit 827). Furthermore, the antenna unit 110 may be implemented in the antenna 810. Moreover, the network communication unit 130 may be implemented in the controller 821 and/or the network interface 823. Furthermore, the storage unit 140 may be implemented in the memory 822.

### Second Application

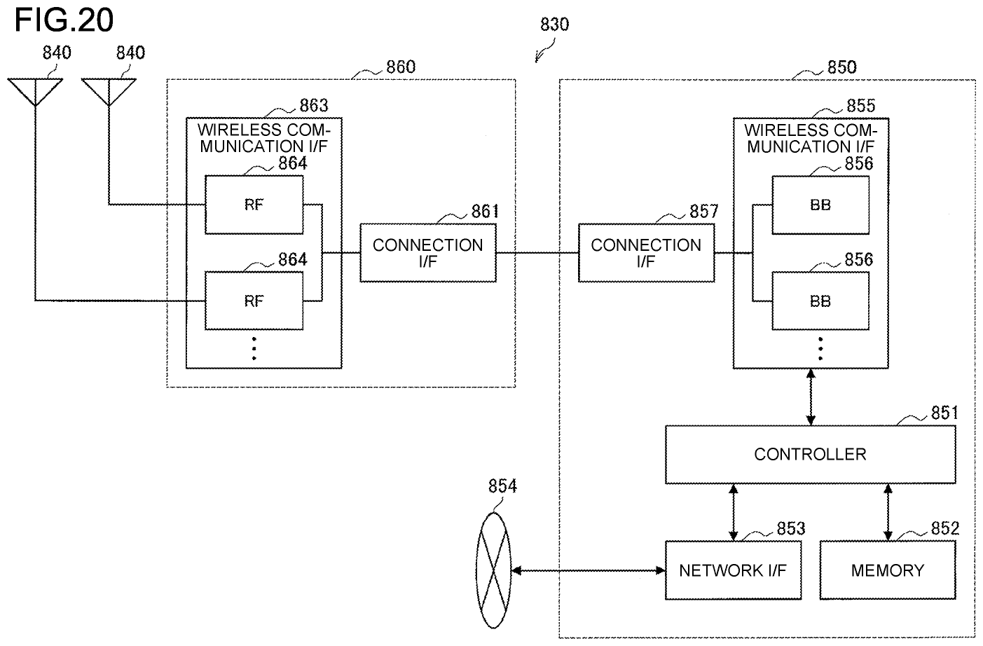

FIG. 20 is a block diagram illustrating a second example of a schematic configuration of eNB to which the technique according to the present disclosure can be applied. An eNB 830 includes one or more antennas 840, a base station device 850, and an RRH 860. Each of the antennas 840 and the RRH 860 can be connected to each other through an RF cable. Moreover, the base station device 850 and the RRH 860 can be connected to each other by a high speed line, such as an optical fiber cable.

Each of the antennas 840 includes a single or plural antenna devices (for example, plural antenna devices constituting a MIMO antenna), and is used for transmission and reception of a wireless signal by the RRH 860. The eNB 830 includes the plural antennas 840 as illustrated in FIG. 20 and, for example, the plural antennas 810 may respectively correspond to plural frequency bands used by the eNB 800. Although an example in which the eNB 830 includes plural units of the antennas 840 has been described, the eNB 830 may include a single unit of the antenna 840.

The base station device 850 includes a controller 851, a memory 852, a network interface 853, a wireless communication interface 855, and a connection interface 857. The controller 851, the memory 852, and the network interface 853 are similar to the controller 821, the memory 822, and the network interface 823 explained with reference to FIG. 19.

The wireless communication interface 855 supports any of cellular communication methods, such as LTE or LTE-Advanced, and provides wireless connection to a terminal positioned in a sector corresponding to the RRH 860 through the RRH 860 and the antenna 840. The wireless communication interface 855 can include, typically, a BB processor 856, and the like. The BB processor 856 is similar to the BB processor 826 explained with reference to FIG. 19, except that it is connected to a RF circuit 864 of the RRH 860 through the connection interface 857. The wireless communication interface 855 includes plural units of the BB processors 856 as illustrated in FIG. 20, and the plural BB processors 856 may respectively correspond, for example, to plural frequency bands used by the eNB 830. Although an example in which the wireless communication interface 855 includes plural units of the BB processors 856 has been illustrated in FIG. 20, the wireless communication interface 855 may include a single unit of the BB processor 856.

The connection interface 857 is an interface to connect the base station device 850 (the wireless communication interface 855) to the RRH 860. The connection interface 857 may be a communication module for communication by the high speed line connecting the base station device 850 (the wireless communication interface 855) and the RRH 860.

Moreover, the RRH 860 includes a connection interface 861 and a wireless communication interface 863.

The connection interface 861 is an interface to connect the RRH 860 (the wireless communication interface 863) to the base station device 850. The connection interface 861 may be a communication module for communication by the high speed line described above.

The wireless communication interface 863 transmits and receives a wireless signal through the antenna 840. The wireless communication interface 863 can include the RF circuit 864 and the like. The RF circuit 864 may include a mixer, a filter, an amplifier, and the like, and transmits and receives a wireless signal through the antenna 840. The wireless communication interface 863 includes plural units of the RF circuit 864 as illustrated in FIG. 20, and the plural units of the RF circuit 864 may correspond, for example, respectively to the plural antenna devices. Although an example in which the wireless communication interface 863 includes plural units of the RF circuits 864 has been illustrated in FIG. 20, the wireless communication interface 863 may include a single unit of the RF circuit 864.

In the eNB 830 illustrated in FIG. 20, at least one of the components (the setting unit 151, and/or the communication control unit 153) included in the control unit 150 explained with reference to FIG. 8 may be contained in the wireless communication interface 855 and/or the wireless communication interface 863. Alternatively, at least a part of these components may be contained in the controller 851. As an example, the eNB 830 may have a module including a part or all of the wireless communication interface 855 (for example, the BB processor 856), and/or the controller 851 mounted therein, and at least one of the components described above may be implemented in the module. In this case, the module described above may store a program to cause a processor to function as at least one of the components described above (in other words, a program to cause the processor to perform an operation of at least one of the components described above), and may execute the program. As another example, a program to cause the processor to function as at least one of the components described above may be installed in the eNB 830, and the wireless communication interface 855 (for example, the BB processor 856) and/or the controller 851 may execute the program. As described above, the eNB 830, the base station device 850, or the module described above may be provided as a device that has at least one of the components described above, and a program to cause the processor to function as at least one of the components described above may be provided. Furthermore, a readable recording medium that stores the program described above may be provided.

Moreover, in the eNB 830 illustrated in FIG. 20, the wireless communication unit 120 explained with reference to FIG. 10 may be implemented in the wireless communication interface 863 (for example, the RF circuit 864). Furthermore, the antenna unit 110 may be implemented in the antenna 840. Moreover, the network communication unit 130 may be implemented in the controller 851 and/or the network interface 853. Furthermore, the storage unit 140 may be implemented in the memory 852.

### 5.2 Application Relating to Terminal Device

### First Application

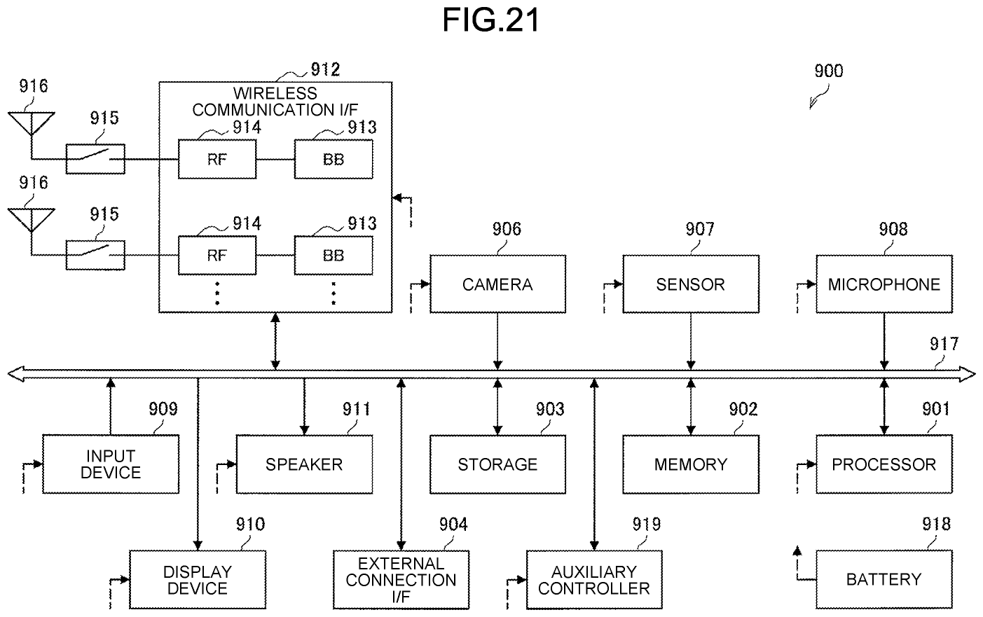

FIG. 21 is a block diagram illustrating an example of a schematic configuration of a smartphone 900 to which the technique according to the present disclosure can be applied. The smartphone 900 includes a processor 901, a memory 902, a storage 903, an external connection interface 904, a camera 906, a sensor 907, a microphone 908, an input device 909, a display device 910, a speaker 911, a wireless communication interface 912, one or more antenna switches 915, one or more antennas 916, a bus 917, a battery 918, and an auxiliary controller 919.

The processor 901 may be, for example, a CPU or a system on chip (SoC), and controls functions of an application layer and other layer of the smartphone 900. The memory 902 includes a RAM and a ROM, and stores a program that is executed by the processor 901 and data. The storage 903 can include a storage medium, such as a semiconductor memory and a hard disk. The external connection interface 904 is an interface to connect an external device, such as a memory car or a universal serial bus (USB) device, to the smartphone 900.

The camera 906 includes an imaging device, such as a charge coupled device (CCD) or a complementary metal oxide semiconductor (CMOS), and generates a captured image. The sensor 907 can include a sensor group of, for example, a positioning sensor, a gyro sensor, a geomagnetic sensor, an acceleration sensor, and the like. The microphone 908 converts a sound input to the smartphone 900 into a sound signal. The input device 909 includes, for example, a touch sensor that detects a touch on a screen of the display device 910, a keypad, a keyboard, a button, a switch, or the like, and accepts an operation or information input from a user. The display device 910 includes a screen of a liquid display (LCD), an organic light emitting diode (OLED) display, or the like, and displays an output image of the smartphone 900. The speaker 911 converts a sound signal output from the smartphone 900 into a sound.

The wireless communication interface 912 supports any of cellular communication methods, such as LTE or LTE-Advanced, and performs wireless communication. The wireless communication interface 912 can include, typically, a BB processor 913, an RF circuit 914, and the like. The BB processor 913 may perform, for example, encoding/decoding, modulation/demodulation, multiplexing/demultiplexing, and the like, and performs various signal processing for wireless communication. On the other hand, the RF circuit 914 may include a mixer, a filter, an amplifier, and the like, and transmits and receives a wireless signal through the antenna 916. The wireless communication interface 912 may be a one-chip module in which the BB processor 913 and the RF circuit 914 are integrated. The wireless communication interface 912 may include plural units of the BB processors 913 and plural units of the RF circuits 914 as illustrated in FIG. 21. Although an example in which the wireless communication interface 912 includes plural units of the BB processors 913 and plural units of the RF circuit 914 has been illustrated in FIG. 21, the wireless communication interface 912 may include a single unit of the BB processor 913 or a single unit of the RF circuit 914.

Furthermore, the wireless communication interface 912 may support other kinds of wireless communication methods, such as near field communication, proximity wireless communication, or local area network(LAN), in addition to the cellular communication method, and in that case, may include the BB processor 913 and the RF circuit 914 for each wireless communication method.

Each of the antenna switches 915 switches a connection destination of the antenna 916 among plural circuits (for example, circuits for different wireless communication methods) included in the wireless communication interface 912.

Each of the antennas 916 includes one or more antenna devices (for example, plural antenna devices constituting a MIMO antenna), and is used for transmission and reception of a wireless signal by the wireless communication interface 912. The smartphone 900 may include plural units of the antennas 916 as illustrated in FIG. 21. Although an example in which the smartphone 900 includes plural units of the antennas 916 has been illustrated in FIG. 21, the smartphone 900 may include a single unit of the antenna 916.

Furthermore, the smartphone 900 may include the antenna 916 for each wireless communication method. In that case, the antenna switch 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the wireless communication interface 912, and the auxiliary controller 919 with one another. The battery 918 supplies power to each block of the smartphone 900 illustrate in FIG. 21 through a power supply line partially indicated by broken lines in the drawing. The auxiliary controller 919 operates a minimum necessary function of the smartphone 900, for example, in a sleep mode.

In the smartphone 900 illustrated in FIG. 21, at least one of the components (the acquiring unit 241 and/or the communication control unit 243) included in the control unit 240 explained with reference to FIG. 21 may be contained in the wireless communication interface 912. Alternatively, at least a part of these components may be contained in the processor 901 or the auxiliary controller 919. As an example, the smartphone 900 may have a module including a part or all of the wireless communication interface 912 (for example, the BB processor 913), the processor 901, and/or the auxiliary controller 919 mounted therein, and at least one of the components described above may be implemented in the module. In this case, the module described above may store a program to cause a processor to function as at least one of the components described above (in other words, a program to cause the processor to perform an operation of at least one of the components described above), and may execute the program. As another example, a program to cause the processor to function as at least one of the components described above may be installed in the smartphone 900, and the wireless communication interface 912 (for example, the BB processor 913), the processor 901, and/or the auxiliary controller 919 may execute the program. As described above, the smartphone 900 or the module described above may be provided as a device that has at least one of the components described above, and a program to cause the processor to function as at least one of the components described above may be provided. Furthermore, a readable recording medium that stores the program described above may be provided.

Moreover, in the smartphone 900 illustrated in FIG. 21, the wireless communication unit 220 explained with reference to FIG. 9 may be implemented in the wireless communication interface 912 (for example, the RF circuit 914). Furthermore, the antenna unit 210 may be implemented in the antenna 916. Moreover, the storage unit 230 may be implemented in the memory 902.

### Second Application

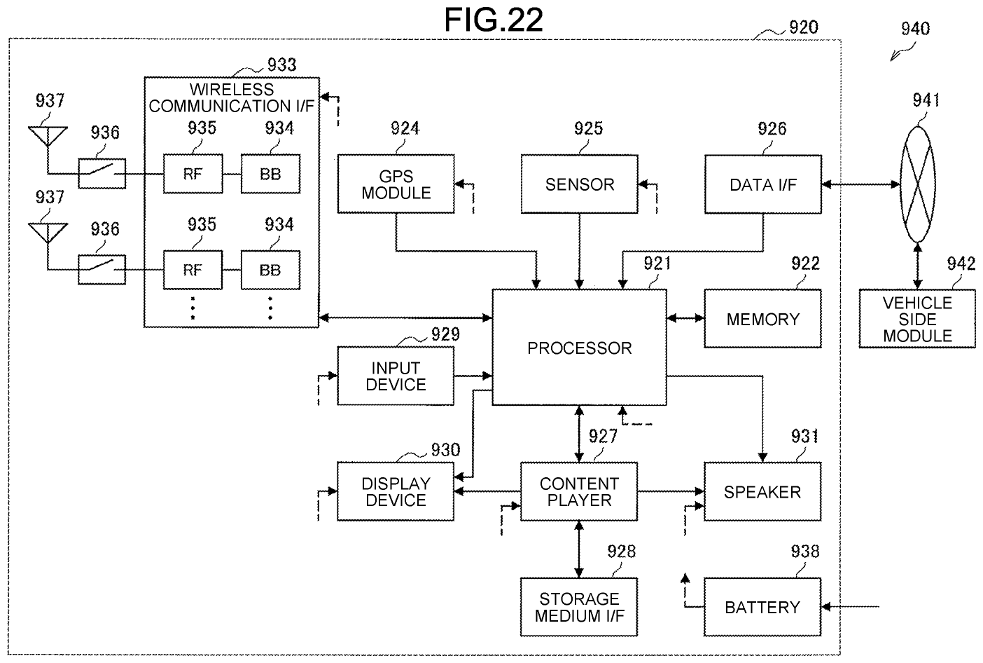

FIG. 22 is a block diagram illustrating an example of a schematic configuration of a car navigation device 920 to which the technique according to the present disclosure can be applied. The car navigation device 920 includes a processor 921, a memory 922, a global positioning system (GPS) module 924, a sensor 925, a data interface 926, a content player 927, a storage medium interface 928, an input device 929, a display device 930, a speaker 931, a wireless communication interface 933, at least one of an antenna switch 936, at least one of antenna 937, and a battery 938.

The processor 921 may be, for example, a CPU or an SoC, and controls a navigation function and other functions of the car navigation device 920. The memory 922 includes a RAM and a ROM, and stores a program that is executed by the processor 921 and data.

The GPS module 924 measures a position (for example, latitude, longitude, and altitude) of the car navigation device 920 by using a GPS signal received from a GPS satellite. The sensor 925 can include a sensor group of, for example, a gyro sensor, a geomagnetic sensor, a barometer sensor, and the like. The data interface 926 is connected to an in-car network 941, for example, through a terminal not shown, and acquires data generated in the vehicle, such as vehicle speed data.

The content player 927 reproduces contents stored in a storage medium (for example, a CD or a DVD) inserted in to the storage medium interface 928. The input device 929 includes, for example, a touch sensor that detects a touch on a screen of the display device 930, a button, a switch, or the like, and accepts an operation or information input from a user. The display device 930 includes a screen of an LCD or OLED display, or the like, and displays navigation functions or an image of the reproduced contents. The speaker 931 converts a sound of the navigation functions or the reproduced contents into a sound.

The wireless communication interface 933 supports any of cellular communication methods, such as LTE or LTE-Advanced, and performs wireless communication. The wireless communication interface 933 can include, typically, a BB processor 934, an RF circuit 935, and the like. The BB processor 934 may perform, for example, encoding/decoding, modulation/demodulation, multiplexing/demultiplexing, and the like, and performs various signal processing for wireless communication. On the other hand, the RF circuit 935 may include a mixer, a filter, an amplifier, and the like, and transmits and receives a wireless signal through the antenna 937. The wireless communication interface 933 may be a one-chip module in which the BB processor 934 and the RF circuit 935 are integrated. The wireless communication interface 933 may include plural units of the BB processors 934 and plural units of the RF circuits 935 as illustrated in FIG. 22. Although an example in which the wireless communication interface 933 includes plural units of the BB processors 934 and plural units of the RF circuit 935 has been illustrated in FIG. 22, the wireless communication interface 933 may include a single unit of the BB processor 934 or a single unit of the RF circuit 935.

Furthermore, the wireless communication interface 933 may support other kinds of wireless communication methods, such as near field communication, proximity wireless communication, or wireless LAN, in addition to the cellular communication method, and in that case, may include the BB processor 934 and the RF circuit 935 for each wireless communication method.

Each of the antenna switches 936 switches a connection destination of the antenna 937 among plural circuits (for example, circuits for different wireless communication methods) included in the wireless communication interface 933.

Each of the antennas 937 includes one or more antenna devices (for example, plural antenna devices constituting a MIMO antenna), and is used for transmission and reception of a wireless signal by the wireless communication interface 933. The car navigation device 920 may include plural units of the antennas 937 as illustrated in FIG. 22. Although an example in which the car navigation device 920 includes plural units of the antennas 937 has been illustrated in FIG. 22, the car navigation device 920 may include a single unit of the antenna 937.

Furthermore, the car navigation device 920 may include the antenna 937 for each wireless communication method. In that case, the antenna switch 936 may be omitted from the configuration of the car navigation device 920.

The battery 938 supplies power to each block of the car navigation device 920 illustrated in FIG. 22 through a power supply line partially indicated by broken lines in the drawing. Moreover, the battery 938 accumulates power supplied from a vehicle.

In the car navigation device 920 illustrated in FIG. 22, at least one of the components (the acquiring unit 241 and/or the communication control unit 243) included in the control unit 240 explained with reference to FIG. 9 may be contained in the wireless communication interface 933. Alternatively, at least a part of these components may be contained in the processor 921. As an example, the car navigation device 920 may have a module including a part or all of the wireless communication interface 933 (for example, the BB processor 934), and/or the processor 921 mounted therein, and at least one of the components described above may be implemented in the module. In this case, the module described above may store a program to cause a processor to function as at least one of the components described above (in other words, a program to cause the processor to perform an operation of at least one of the components described above), and may execute the program. As another example, a program to cause the processor to function as at least one of the components described above may be installed in the car navigation device 920, and the wireless communication interface 933 (for example, the BB processor 934), and/or the processor 921 may execute the program. As described above, the car navigation device 920 or the module described above may be provided as a device that has at least one of the components described above, and a program to cause the processor to function as at least one of the components described above may be provided. Furthermore, a readable recording medium that stores the program described above may be provided.

Moreover, in the car navigation device 920 illustrated in FIG. 22, for example, the wireless communication unit 220 explained with reference to FIG. 9 may be implemented in the wireless communication interface 933 (for example, the RF circuit 935). Furthermore, the antenna unit 210 may be implemented in the antenna 937. Moreover, the storage unit 230 may be implemented in the memory 922.

Furthermore, the technique according to the present disclosure may be implemented as an in-car system (or a vehicle) including at least one block of the car navigation device 920 described above, the in-car network 941, and a vehicle side module 942. The vehicle side module 942 generates vehicle side data, such as vehicle speed, an engine speed, failure information, and the like, and outputs the generated data to the in-car network 941.

### 6. SUMMARY

As explained above, according to the first embodiment of the present disclosure, the terminal device 200 that specifies a beam link to be suspended by using the beam ID that is one to one mapped to a beam report, and the base station 100 that notifies the beam link ID that is one to one mapped to a beam report to the terminal device 200 are provided.

Moreover, according to the second embodiment of the present disclosure, the terminal device 200 that receives settings of priority of transmission beams to be used for a beam recovery request from a network, and that operates according to the priory of a beam, and the base station 100 that notifies of such settings of priority to the terminal device 200 are provided.

The respective steps of processing performed by the respective devices of the present specification are not necessarily required to be processed chronologically according to order described as a sequence diagram or a flowchart. For example, the respective steps in the processing performed by the respective devices may be processed in order different from the order described as a flowchart, or may be processed in parallel.

Furthermore, a computer program to cause hardware such as the CPU, the ROM and the RAM included in the respective devices to have functions equivalent to the functions of the respective devices described above can also be created. Moreover, a storage medium in which the computer program is stored can also be provided. Furthermore, by configuring the respective functional blocks illustrated in the functional block diagram with hardware, a series of processing can be implemented by hardware.

As above, exemplary embodiments of the present disclosure have been explained in detail with reference to the accompanying drawings, but a technical scope of the present disclosure is not limited to the examples. It is obvious that those who have ordinary knowledge in the technical field of the present disclosure can think of various modification examples and correction examples within a scope of technical ideas described in claims, and these are also understood naturally to belong to the technical scope of the present disclosure.

Moreover, effects described in the present application are only for explanation and examples, and are not limited. That is, the technique according to the present disclosure can produce other effects obvious to those skilled in the art from the description of the present specification, in addition to the effects described above, or in place of the effects described above.

Note that following configurations also belong to the technical scope of the present disclosure.

(1)

A communication device comprising:

an acquiring unit that acquires a beam link identifier in one to one correspondence with a measurement result of a beam transmitted from a base station; and

a communication control unit that specifies a beam link with the base station to be suspended, by using the beam link identifier.

(2)

The communication device according to (1), wherein

the communication control unit notifies of a maximum number of beam links to be subjected to maintenance to the base station, together with the beam measurement result.

(3)

The communication device according to (2), wherein

the communication control unit notifies of the maximum number for each bandwidth part (BWP).

(4)

A communication device comprising:

an acquiring unit that acquires setting of priority of a beam to be used for a recovery request of a beam with respect to a base station; and

a communication control unit that selects a beam to be used for a recovery request based on the priority.

(5)

The communication device according to (4), wherein

the communication control unit transmits the recovery request to the base station by a random access resource in a different beam from the beam in which a disconnection of a link with the base station has been detected.

(6)

The communication device according to (5), wherein

the different beam is two or more beams.

(7)

The communication device according to (5) or (6), wherein

the communication control unit performs a recovery request of a beam collectively for disconnection of a plurality of links as a single message in a single random access resource.

(8)

The communication device according to (7), wherein

a threshold of detection time for disconnection of a link to be able to output a single recovery request of a beam with the single message is set.

(9)

The communication device according to any one of (4) to (8), wherein

the communication control unit transmits, to the base station, the recovery request by a single random access resource to be used for a resource to detect disconnection of two or more links.

(10)

A communication control device comprising:

a communication control unit that sets a beam link identifier in one to one correspondence with a measurement result of a beam from a terminal device relating to a beam to be transmitted; and

an acquiring unit that acquires information relating to a beam link to be suspended by the terminal device receiving the beam, by using the beam link identifier.

(11)

The communication control unit according to (10), wherein

the acquiring unit acquires a maximum number of beam links to be subjected to maintenance together with the measurement result of the beam from the terminal device.

(12)

The communication control device according to (11), wherein

the acquiring unit acquires the maximum number for each bandwidth part (BWP).

(13)

A communication control device comprising:

a communication control unit that transmits setting of priority of a beam to be used for a recovery request of a beam with respect to a terminal device; and

an acquiring unit that acquires information relating to a beam selected to be used for a recovery request based on the priority.

(14)

The communication control device according to (13), wherein

the acquiring unit acquires the recovery request transmitted by a random access resource in a different beam from a beam in which disconnection of a link with the terminal device has been detected.

(15)

The communication control device according to (14), wherein

the different beam is two or more beams.

(16)

The communication control device according to (14) or (15), wherein

the acquiring unit acquires a recovery request of a beam made collectively to disconnection of a plurality of links as a single message of a single random access resource.

(17)

The communication control device according to (16), wherein

the communication control unit sets a threshold of detection time for disconnection of a link to be able to output a single recovery request of a beam with the single message.

(18)

The communication control device according to any one of (13) to (17), wherein

the acquiring unit acquires the recovery request transmitted by a single random access resource to be used for a resource to detect disconnection of two or more links.

(19)

A communication method comprising:

acquiring a beam link identifier in one to one correspondence with a measurement result of a beam relating to a beam transmitted from a base station; and

specifying a beam link to be suspended with respect to the base station, by using the beam link identifier.

(20)

A communication control method comprising:

setting a beam link identifier in one to one correspondence with a measurement result of a beam from a terminal device relating to a beam to be transmitted; and

acquiring information relating to a beam link to be suspended by the terminal device that receives the beam by using the beam link identifier.

### REFERENCE SIGNS LIST

100 BASE STATION

200 TERMINAL DEVICE

1. A communication device comprising:
an acquiring unit that acquires a beam link identifier in one to one correspondence with a measurement result of a beam transmitted from a base station; and
a communication control unit that specifies a beam link with the base station to be suspended, by using the beam link identifier.

2. The communication device according to claim 1, wherein
the communication control unit notifies of a maximum number of beam links to be subjected to maintenance to the base station, together with the beam measurement result.

3. The communication device according to claim 2, wherein
the communication control unit notifies of the maximum number for each bandwidth part (BWP).

4. A communication device comprising:
an acquiring unit that acquires setting of priority of a beam to be used for a recovery request of a beam with respect to a base station; and
a communication control unit that selects a beam to be used for a recovery request based on the priority.

5. The communication device according to claim 4, wherein
the communication control unit transmits the recovery request to the base station by a random access resource in a different beam from the beam in which a disconnection of a link with the base station has been detected.

6. The communication device according to claim 5, wherein
the different beam is two or more beams.

7. The communication device according to claim 5, wherein
the communication control unit performs a recovery request of a beam collectively for disconnection of a plurality of links as a single message in a single random access resource.

8. The communication device according to claim 7, wherein
a threshold of detection time for disconnection of a link to be able to output a single recovery request of a beam with the single message is set.

9. The communication device according to claim 4, wherein
the communication control unit transmits, to the base station, the recovery request by a single random access resource to be used for a resource to detect disconnection of two or more links.

10. A communication control device comprising:
a communication control unit that sets a beam link identifier in one to one correspondence with a measurement result of a beam from a terminal device relating to a beam to be transmitted; and
an acquiring unit that acquires information relating to a beam link to be suspended by the terminal device receiving the beam, by using the beam link identifier.

11. The communication control unit according to claim 10, wherein
the acquiring unit acquires a maximum number of beam links to be subjected to maintenance together with the measurement result of the beam from the terminal device.

12. The communication control device according to claim 11, wherein
the acquiring unit acquires the maximum number for each bandwidth part (BWP).

13. A communication control device comprising:
a communication control unit that transmits setting of priority of a beam to be used for a recovery request of a beam with respect to a terminal device; and
an acquiring unit that acquires information relating to a beam selected to be used for a recovery request based on the priority.

14. The communication control device according to claim 13, wherein
the acquiring unit acquires the recovery request transmitted by a random access resource in a different beam from a beam in which disconnection of a link with the terminal device has been detected.

15. The communication control device according to claim 14, wherein
the different beam is two or more beams.

16. The communication control device according to claim 14, wherein
the acquiring unit acquires a recovery request of a beam made collectively to disconnection of a plurality of links as a single message of a single random access resource.

17. The communication control device according to claim 16, wherein
the communication control unit sets a threshold of detection time for disconnection of a link to be able to output a single recovery request of a beam with the single message.

18. The communication control device according to claim 13, wherein
the acquiring unit acquires the recovery request transmitted by a single random access resource to be used for a resource to detect disconnection of two or more links.

19. A communication method comprising:
acquiring a beam link identifier in one to one correspondence with a measurement result of a beam relating to a beam transmitted from a base station; and
specifying a beam link to be suspended with respect to the base station, by using the beam link identifier.

20. A communication control method comprising:
setting a beam link identifier in one to one correspondence with a measurement result of a beam from a terminal device relating to a beam to be transmitted; and
acquiring information relating to a beam link to be suspended by the terminal device that receives the beam by using the beam link identifier.
